(19) United States
(12) Patent Application Publication
(10) Pub. No.: US 2009/0139129 A1
(43) Pub. Date: Jun. 4, 2009

(54) SAMPLING DEVICE

(75) Inventor: Brendan John Hicks, Hamilton (NZ)

Correspondence Address: KNOBBE MARTENS OLSON & BEAR LLP, 2040 MAIN STREET, FOURTEENTH FLOOR, IRVINE, CA, 92614, US

(73) Assignee: Waikatolink Limited, Hamilton (NZ)

(21) Appl. No.: 11/949,704

(22) Filed: Dec. 3, 2007

(51) Int. Cl. A01K 75/00; A01K 71/00; A01K 79/00

(52) U.S. Cl. 43/4.5; 43/7; 43/8

(57) ABSTRACT

The present invention relates to a sampling device for capturing samples from a fluid environment. The invention has particular application to the capture of phytoplankton samples from bodies of water.

The invention is adapted to allow a sampling net to be easily manipulated by a user. Means of minimising and/or eliminating potential contamination of any collected samples are also provided.

### BACKGROUND OF THE INVENTION

1. Field of the Invention

The present invention relates to a sampling device for capturing samples from a fluid environment. The invention has particular application to the capture of phytoplankton samples from bodies of water.

2. Description of the Related Art

New Zealand has a well deserved reputation for sparkling clear freshwater river and streams. This is particularly the case for rivers and streams which drain catchment areas in which there is little or no agricultural or forestry activity to contribute excessive nutrients to the freshwater ecosystem.

These clear waterways support a thriving fishery and tourism industry which has recently come under significant threat from the introduction of Didymosphenia geminata (Didymo—commonly referred to as rock snot), a particularly invasive freshwater diatom which already adversely affects stream ecosystems in North America and Europe.

Didymo is an undesirable aquatic plant which causes unsightly growth in infected waterways and displaces native flora and fauna species by reducing available habitat.

It is estimated that by 2014, Didymo will have caused a loss of up to $285 million to New Zealand's economy due to its impact on tourism, the fishing industry, and waterway infrastructure such as dams and culverts.

In New Zealand, Didymo at present is confined to the South Island. Biosecurity New Zealand, along with a number of other New Zealand agencies, have instigated monitoring of North Island waterways, as well as continuing the monitoring and sampling of South Island waterways to provide information useful for developing a containment strategy for Didymo and long term management objectives.

The methods of monitoring include visual inspections, benthic sampling (scraping the substrate of stream beds for samples) and drift net sampling.

The inventor has determined that drift net sampling is particularly useful for monitoring purposes as it allows detection of Didymo growing further upstream from the site being sampled. Visual and benthic samples are much more site specific techniques for testing for presence of Didymo.

Further more, both these techniques require a relatively high level of Didymo cells to effectively detect the presence of Didymo.

One apparatus used for generic drift net sampling is a plankton net. Plankton nets are made from a nylon mesh, the size of which varies according to the requirements of the user. The mouth of the net is substantially greater in diameter than the tail of the net, resembling a funnel in cross-section.

The tail of the net is connected to the neck of a bottle or similar collector, which retains the sample being collected.

Present plankton nets are provided with a collar and bridle for the net. The collar runs around the circumference of the mouth of the net, with the bridle being attached to the collar at several points. The bridle can then be tied or otherwise attached to a stake, rod or Waratah™ fence post. In use, the strength of the water flow of the stream carries the plankton net downstream of the stake.

The use of present plankton nets for drift net sampling of Didymo has a number of disadvantages.

Avoiding contamination of the sample is critical. A particularly sensitive DNA probe has been developed to detect Didymo. A single Didymo cell is sufficient to give a positive result. Therefore, it is important that equipment used for sampling be thoroughly cleaned in between sampling sites.

It will be appreciated that the stake and bridle impedes the water flow to the collector at the tail of the plankton net. Being upstream of the sampling net, the stake and bridle can provide surfaces on which microscopic particles (such as Didymo cells) be trapped. When removing and re-establishing the plankton net at another site, there is the potential for any cells trapped on the bridle or stake at the previous site to be released into the collector, contaminating the sample, and giving a false positive for Didymo at the new stream or site.

An even worse scenario, is the accidental release of trapped Didymo cells from the stake or bridle into an unaffected waterway, spreading Didymo further.

Therefore, as noted above, the apparatus has to be cleaned particularly well in between sampling sites. However, stakes constructed from porous material such as wood, rusted metal or the like, can be difficult to clean thoroughly. The ties of the bridle can also be difficult to clean thoroughly. Didymo can survive for prolonged periods of time, so long as it has sufficient moisture.

It is desirable when sampling for the presence of Didymo to be sampling flowing water. This increases the chances of detecting the presence of Didymo in a particular stream, as Didymo cells from upstream can be carried for significant lengths of a waterway.

The plankton net must held in the water for a sufficient period of time to accumulate a sufficient sample size to assess for presence or absence of Didymo. Present sampling protocols developed by the National Institute of Water and Atmospheric Research (NIWA) stipulate that the water must be continually sampled for 10 minutes.

As discussed above, a stake driven into the stream bed is used to support the plankton net. It can be difficult to drive a stake into the stream bed for this purpose, particularly if the stream bed has largely a bedrock or boulder substrate.

An alternative to minimise the risk of contamination is for the user to hold the plankton net by its sides rather than use stakes and the bridle of the plankton net. This can be difficult to do for extended periods of time, particularly in streams fed by high country catchments, as the water can be chilly even in summer.

There is also a risk of danger to the user when physically holding the nets in flowing waters. Typically, users of plankton nets will be wearing neoprene waders when sampling. These waders can rapidly fill with water and become very water logged should the user become fully immersed in water.

Conventional plankton nets are often made of fabric that does not stand up to wear and tear. Cleaning of these nets using harsh chemicals such as bleach also degrades the netting fabric. To repair worn or damaged nets can be labour intensive, and typically the nets are usually replaced rather than repaired.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### SUMMARY OF THE INVENTION

### Disclosure of Invention

According to one aspect of the present invention there is provided a sampling device for collecting samples from a fluid environment, which includes; a mouth, a fine filter to capture the preferred samples to be collected from the fluid, netting material to allow passage of fluid from the mouth of the sampling device to the fine filter, and a coarse filter situated in proximity to the mouth of the sampling device.

According to another aspect of the present invention there is provided a sampling device for collecting samples from a fluid environment which includes; netting material having a mouth, and a handle, affixed tangently to the mouth of the netting material.

According to another aspect of the present invention there is provided a sampling device for collecting samples from a fluid environment, which includes a netting material having a mouth, a handle, and a support for the handle, the support being affixed tangently to the mouth and extending the functional length of the handle.

According to yet another aspect of the present invention, there is provided a sampling device for collecting samples from a fluid environment, which includes netting material having a tail, a sample collector situated in the proximity of the tail of the netting material, and an attachment device to attach the collector to the tail, the collector including a filter distal to the attachment device.

According to yet another aspect of the present invention, there is provided a method of using a sampling device for collecting samples from a fluid environment which includes the steps of: a) immersing the sampling device in a body of water, b) collecting samples using the sampling device from a body of water, and the additional step of: c) adding a coarse filter to the sampling device before collecting samples.

A sampling device may be any device configured to capture samples from a fluid environment. Preferably, the sampling device is in the form of a netting material.

The fluid environment may be a body of water, for example such the ocean, or a lake.

Preferably, the fluid environment is in a constant state of movement, such as running water as found in rivers and streams and their tributaries and shall be referred to as such throughout the remainder of this specification. However, persons skilled in the art will appreciate the present invention may be used in a tidal environment, such as an estuary or beach, or from a moving boat.

The present invention is particularly useful for drift sampling.

The samples to be collected may be of any physical, chemical, or biological origin. For example, the sample may be mineral particles such as iron or silica.

Preferably, the particles are suspended micro-flora such as algae or diatoms (phytoplankton) or suspended micro-fauna such as zooplankton and shall be referred to as such throughout the remainder of this specification. However, persons skilled in the art will appreciate the present invention may also be used for sampling aquatic invertebrates, their larvae and other micro-organisms present in bodies of water.

The present invention is particularly useful for the sampling of Didymo.

The mouth of the sampling device is preferably construed to mean an open larger end of a sampling net. The mouth of the sampling net may include means for maintaining the mouth of the sampling net in an operative condition. This may be achieved using a thin frame of plastic, metal or similar material. Preferably, the sampling net is constructed from netting material.

Netting material should be understood to mean material which permits passage of liquid while trapping minute particles carried by the fluid through the netting material. Preferably, the netting material is constructed from mesh such as Nitex® nylon. Nylon is preferable due to the ease with which it can be replaced. The preferred chemical for cleaning the nylon is bleach, which can degrade the mesh over time.

Preferably, the netting material is a mesh of 40 microns, which is a size permitting the passage of water while capturing Didymo cells. However, persons skilled in the art will appreciate that the dimensions of the mesh will vary according to the sampling requirements of the user.

The fine filter should be understood to mean a filter with a mesh being of a size small enough to retain the targeted micro-fauna, but large enough to permit passage of water through the filter.

Preferably, the mesh of the fine filter is 40 microns, which is a dimension which will ensure capture of Didymo particles while still allowing water to pass through the filter. However, persons skilled in the art will appreciate that the dimensions of the mesh will vary according to the sampling requirements of the user.

The coarse filter should be understood to mean a filter substantially larger than the size of the particle being sampled. Preferably the course filter is of a 250 micron mesh weave.

The inventor has found that this size mesh is sufficient to exclude twigs, leaves and extraneous drifting debris carried by flowing stream waters that might otherwise be trapped by the fine filter and potentially contaminate collected samples. However, persons skilled in the art will appreciate that the dimensions of the coarse filter will vary according to the sampling requirements of the user.

In preferred embodiments of the present invention the mouth of the sampling net includes an interface between the net and the coarse filter.

The interface may be any means of placing the coarse filter in proximity to the mouth of the sampling net. In preferred embodiments of the present invention, the interface encompasses the circumference, or a substantial part of the circumference of the net mouth.

Preferably, the interface is a collar, and shall be referred to as such throughout the remainder of this specification. Preferably, the collar is constructed from polyvinyl chloride (PVC), although persons skilled in the art will appreciate that any rigid material may be used, for example, other types of plastics or aluminium.

In a preferred embodiment of the present invention, the interior of the collar is moulded with an abutment around its circumference. This provides a surface on which the mouth of the net and the coarse filter may fit when in use.

In one embodiment of the present invention, the interior of the collar is moulded with a recess around its circumference in which the outer edge of a coarse filter may fit.

In preferred embodiments of the present invention, the coarse filter is fitted to the outer, upstream portion of the collar, with the mouth of the net being fitted downstream of the coarse filter, inside the collar.

The handle should be understood to mean any means by which the user can manipulate the sampling device.

In preferred embodiments of the present invention, the handle is fixed tangently to the mouth of the net or collar. This should be understood to mean that that handle does not cross or extend in front of the mouth of the sampling device. Instead, the handle contacts a portion of the circumference of the mouth of the net or the collar.

Placing the handle to the side of the mouth of the sampling device is an important feature of the present invention. This arrangement ensures that the handle, or any portion of the handle, is removed from the path of the water flow to the collector of the present invention. This is particularly advantageous as it reduces potential for cross-contamination of the collected samples.

The support should be understood to mean a means for which the user can rest the sampling device on the bottom of the body of water being sampled. Resting the support on the stream bed can reduce potential fatigue for the user, as less effort is required to maintain the position of the sampling device for extended periods of time.

Preferably, both the handle and support is constructed from sections of polyvinyl chloride (PVC) pipe although persons skilled in the art will appreciate that any rigid material may be used, for example, other types of plastics or aluminium. PVC is preferred for being easily sourced, and the ease in which it can be cleaned.

Preferably the end of each section of PVC pipe is threaded to allow extension of the handle by adding extra lengths as required. This allows the user to disassemble the handle for ease of assembly and transportation. Other methods of connecting each section of PVC pipe are envisaged, such as snap lock fittings or a detent system.

In the preferred embodiment of the present invention, the handle is provided with a bracket complementary to the outer surface of the collar. The bracket is secured to the handle using wing nuts. This bracket also secures the netting material, and collar to the handle. The bracket may be constructed from a PVC moulding or similar plastic or another suitable material such as aluminium.

In the preferred embodiment of the present invention, the bracket may be adjustable to facilitate the use of sampling devices of varying sizes. The bracket may be provided with means to slideably adjust one surface of the bracket relative to another surface of the bracket.

Other embodiments of securing the collar and netting material are envisaged.

The tail of the netting material should be understood to mean the closed, or at least substantially reduced opening relative to the mouth of the netting material.

The sample collector should be understood to mean the container in which the samples are captured and held for later retrieval by the user.

The sample collector may include an attachment device to attach the sample collector to the tail of the netting material. Preferably, the attachment device is two close-fitting concentric PVC rings about the exterior diameter of the sample collector. These attach the tail of the netting material to the sample collector by trapping the netting between the PVC rings. However, persons skilled in the art will appreciate that other attachment devices and methods of securing the tail of the netting material to the sample collector are envisaged.

Preferably the container is of two parts, each part provided with a screw thread to allow the container to separated for removal of the collected samples. The container may be provided with a filter to capture the preferred samples. Preferably, the filter is distal to the attachment device. This should be construed to mean that the filter is downstream of the attachment device when the present invention is in use.

In some embodiments of the present invention, an abutment may be provided for a fine filter to be inserted into the container. Preferably, the abutment runs around the interior circumference of the sample collector to provide a surface on which the outer edges of the fine filter may be rested.

In preferred embodiments of the present invention, the base of the container is constructed from a 40 micron mesh. This allows passage of water through the collector while retaining Didymo samples in the collector. The base of the container unscrews to facilitate removal of the collected samples.

However, persons skilled in the art will appreciate that other configurations for the sample collector, and integrating the fine filter with the collector are envisaged.

The present invention offers a number of advantages over the prior art.

Mounting the means of supporting the net to the side of the mouth of the sampling device reduces the risk of contaminating the sample. This allows for a more accurate determination of the absence or presence of Didymo in a stream or river.

Placing a coarse filter upstream of the fine filter also reduces the risk of contamination of the samples by preventing leaves, twigs, and other waterborne detritus from mixing with the collected samples.

The handle of the sampling device also allows a user to rapidly deploy, easily manipulate and hold the invention steady for an extended period of time. Being constructed of PVC with screw thread fittings, the handle can be quickly assembled and effectively cleaned in between sampling sites.

The handle also does away with the requirement of using support stakes in the stream bed to deploy sampling devices. This also removes another potential sampling contamination source, plus saves time and energy by not requiring stakes to be inserted into a hard substrate.

The handle also allows the user to deploy the present invention in the flow of the stream without having to be physically in the stream. This allows for more rapid sampling as the user will no longer have to put on neoprene waders and traverse stream beds. Sampling can be facilitated from the stream side, or from rocks in the stream or river being sampled.

If the stream side characteristics (lack of dry substrate for a user to traverse to a sampling site) are such that it is necessary to enter the stream waters for sampling, the use of the handle can also reduces fatigue in the user if water conditions are chilly. The user will not have to immerse their hands while holding the sampling device in the water.

The support allows the user to use the sampling device with a greater degree of confidence and safety by letting the substrate bear the weight of the sampling device through the support. This reduces the potential fatigue the user may suffer when sampling, as less effort is required to maintain the position of the sampling device in the stream flow.

### BRIEF DESCRIPTION OF THE DRAWINGS

Further aspects of the present invention will become apparent from the following description which is given by way of example only and with reference to the accompanying drawings in which:

FIG. 1 is a perspective view of the present invention; and

FIG. 2 is a perspective view of the bracket for the collar of the present invention, and

FIG. 3 is an exploded perspective view of the sample collector of the present invention.

### DETAILED DESCRIPTION OF THE PREFERRED EMBODIMENT

### Best Modes for Carrying out the Invention

With reference to the drawings, there is provided a sampling device for capturing samples from a fluid environment.

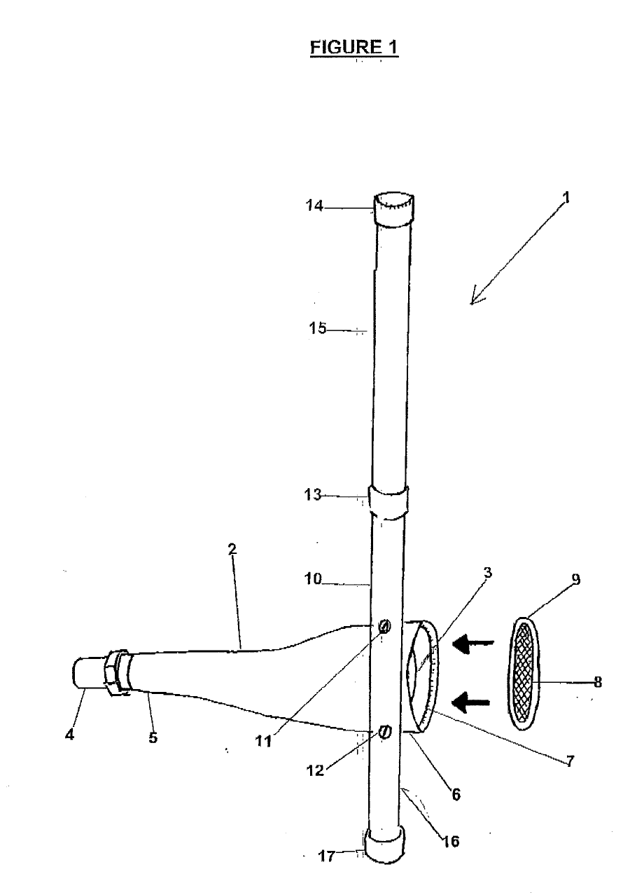

FIG. 1 shows the present invention (generally indicated by arrow 1). The sampling net (2) is provided with a mouth (3) of approximately 160 mm outside diameter, and 150 mm inside diameter. For sake of clarity, the mesh of the sampling net is not shown.

In use, the mouth faces upstream, and samples carried by the water flow will enter the sampling net to be trapped at the collector (4) at the tail (5) of the net.

About the mouth (3) of the sampling net (2) is a collar (6). The collar is constructed from PVC of 170 mm outside diameter, and 160 mm inside diameter. The collar is provided with an abutment (7) on its inside face.

The coarse filter (8), a mesh of 250 microns, is fitted to the collar, the perimeter (9) of the coarse filter being friction fitted to the abutment. The coarse filter has a diameter of 160 mm. It should be noted that the mesh of the coarse filter is shown larger than actual size.

The collar secures the sampling net to a section of the handle (10) via bolts (11, 12) and wing nuts (not shown) through a bracket (not shown). Wing nuts are used to speed assembly and disassembly of the sampling device.

The handle is provided with screw joints (13, 14), allowing the handle sections (10, 15) to allow extra handle sections to be added as required or to allow the sampling device (1) to be easily broken down for shipping and transportation. Each handle section is constructed from 25 mm PVC pipe, and is 500 mm in length.

The support portion of the handle (16) allows the sampling device (1) to rest on the stream bed when the device is being used. The cap (17) prevents damage to the hollow end of the support, and also stops debris from the stream bed entering the inside of the support.

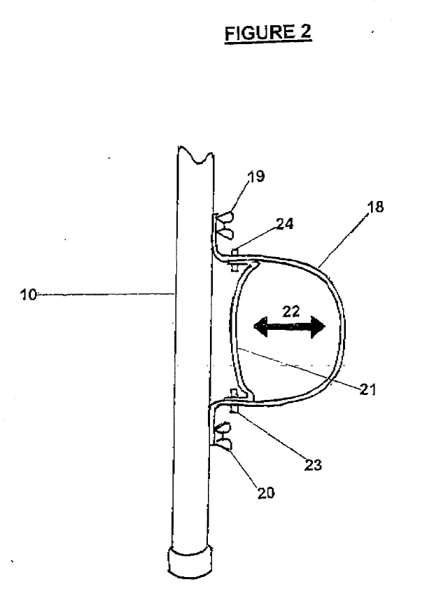

In FIG. 2, the bracket (18) is secured to the handle (10) via stainless steel wing nuts and bolts (19, 20). The inner surface of the bracket (21) is slideably moveable in the direction indicated by arrow 22 by loosening bolts (23, 24). The bracket is fabricated from aluminium.

The bracket engages the collar of the sampling net (not shown) in a friction fit.

Having the inner surface of the bracket moveable allows various sizes sampling nets to be used with the handle.

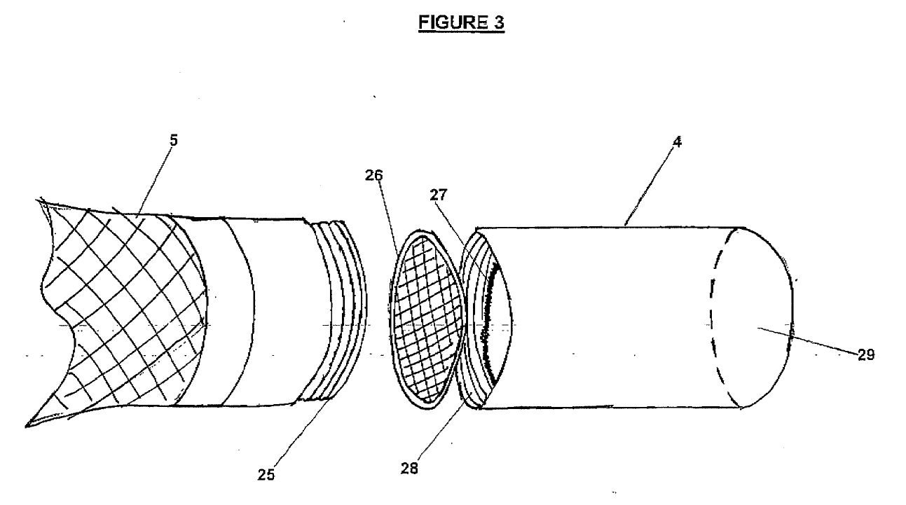

In FIG. 3, the sample collector (4) is attached the tail of the sampling net (5) by a screw fit connection (25). The mesh of the sampling is shown larger than scale.

In one embodiment of the present invention, a fine filter (26) rests on an abutment (27) moulded into the inside of the sample collector. The mesh of the fine filter is shown larger than scale.

The inside of the sample collector also bears screw threads (28) complementary to the screw thread connection (25) of the sampling net (5).

In preferred embodiments of the present invention, the sample collector may be configured with another fine filter at its base (29). This may be supplementary to the fine filter (26), or may be the only fine filter present in the collector.

Aspects of the present invention have been described by way of example only and it should be appreciated that modifications and additions may be made thereto without departing from the scope thereof as defined in the appended claims.

What is claimed is:

1. A sampling device for collecting samples from a fluid environment, which includes;
a mouth,
a fine filter to capture the preferred samples to be collected from the fluid, and;
netting material to allow passage of fluid from the mouth of the sampling device to the fine filter, and
a coarse filter situated in proximity to the mouth of the sampling device.

2. A sampling device as claimed in claim 1 wherein the mouth is the larger open end of a sampling net.

3. A sampling device as claimed in claim 1 wherein the mouth includes a frame to maintain the mouth of the sampling net in an open condition.

4. A sampling device as claimed in claim 1 wherein the mouth includes an interface between the net and the coarse filter.

5. A sampling device as claimed in claim 4 wherein the interface is a collar.

6. A sampling device as claimed in claim 5 wherein the collar encompasses at least a portion of the mouth.

7. A sampling device as claimed in claim 5 wherein the collar encompasses the circumference of the mouth

8. A sampling device as claimed in claim 5 wherein the interior of the collar is provided with an abutment around its circumference complementary to the circumference of the coarse filter.

9. A sampling device as claimed in claim 5 wherein the interior of the collar is provided with a recess around its circumference complementary to the circumference of the coarse filter.

10. A sampling device as claimed in claim 5 wherein the collar is constructed from PVC.

11. A sampling device as claimed in claim 1 wherein the sampling net is constructed from nylon mesh.

12. A sampling device as claimed in claim 1 wherein the mesh of the fine filter is about 40 microns.

13. A sampling device as claimed in claim 1 wherein the mesh of the coarse filter is about 250 microns.

14. A sampling device for collecting samples from a fluid environment which includes;
netting material having a mouth, and,
a handle, the handle being affixed tangently to the mouth of the netting material.

15. A sampling device as claimed in claim 14 wherein the handle is affixed tangently to a collar surrounding the mouth of the netting material.

16. A sampling device as claimed in claim 15 wherein the handle is configured with a bracket complementary to the outer surface of the collar.

17. A sampling device as claimed in claim 16 wherein an inner portion of the bracket is adjustable relative to an outer portion of the bracket.

18. A sampling device as claimed in claim 14 wherein the handle is configured to be broken down into sections.

19. A sampling device as claimed in claim 18 wherein the ends of each section of the handle are provided with a screw thread.

20. A sampling device as claimed in claim 18 wherein the ends of each section of the handle are provided with detents.

21. A sampling device as claimed in claim 18 wherein the ends of each section of the handle are provided with snap lock fittings.

22. A sampling device as claimed in claim 14 wherein the handle is constructed from PVC.

23. A sampling device for collecting samples from a fluid environment, which includes;
a netting material having a mouth,
a handle, and;
a support for the handle, the support being affixed tangently to the mouth and extending the functional length of the handle.

24. A sampling device as claimed in claim 23 wherein the support is affixed tangently to a collar surrounding the mouth of the netting material.

25. A sampling device as claimed in claim 23 wherein the support is configured to broken down into sections.

26. A sampling device as claimed in claim 25 wherein the ends of each section of the support are provided with a screw thread.

27. A sampling device as claimed in claim 25 wherein the ends of each section of the support are provided with detents.

28. A sampling device as claimed in claim 25 wherein the ends of each section of the support are provided with snap lock fittings.

29. A sampling device as claimed in claim 23 wherein the support is constructed from PVC.

30. A sampling device for collecting samples from a fluid environment, which includes;
netting material having a tail,
a sample collector situated in the proximity of the tail of the netting material, the collector including a filter distal to the attachment device, and;
an attachment device to attach the collector to the tail.

31. A sampling device as claimed in claim 30 wherein the collector is configured of two parts.

32. A sampling device as claimed in claim 31 wherein the two parts of the collector are provided with a screw thread to facilitate separation of the collector.

33. A sampling device as claimed in claim 30 wherein the collector comprises a base, the base of the collector including a fine filter.

34. A sampling device as claimed in claim 30 wherein the collector is provided with an abutment around its interior circumference complementary to the circumference of a fine filter.

35. A sampling device as claimed in claim 30 comprising a fine filter having a circumference wherein the collector is provided with a recess around its interior circumference complementary to the circumference of the fine filter.

36. A sampling device as claimed in claim 30 comprising a fine filter comprising a mesh of about 40 microns.

37. A sampling device as claimed in claim 30 wherein the attachment device includes two close-fitting concentric PVC rings about the exterior diameter of the sample collector.

38. A method of using a sampling device for collecting samples from a fluid environment which includes the steps of:
a) immersing the sampling device in a body of water
b) collecting samples using the sampling device from a body of water, and
c) adding a coarse filter to the sampling device before collecting samples.
